(19) United States
(12) Patent Application Publication
(10) Pub. No.: US 2021/0348728 A1
(43) Pub. Date: Nov. 11, 2021

(54) WOODEN BASE OF DESK LAMP

(71) Applicant: Dongguan Chuan OptoElectronics Limited, Dongguan (CN)

(72) Inventor: Yiquan LIU, Dongguan (CN)

(73) Assignee: Dongguan Chuan OptoElectronics Limited, Dongguan (CN)

(21) Appl. No.: 17/380,453

(22) Filed: Jul. 20, 2021

Related U.S. Application Data
(63) Continuation of application No. PCT/CN2019/074782, filed on Feb. 11, 2019.

(30) Foreign Application Priority Data
Jan. 25, 2019 (CN) 201920140660.8

(51) Int. Cl. F21S 6/00; F21V 23/02; F21V 23/04; H02J 50/00

(52) U.S. Cl. CPC F21S 6/002; H02J 50/005; F21V 23/04; F21V 23/023

(57) ABSTRACT

Disclosed is a wooden base of a desk lamp comprising a body, a desk lamp switch and a wireless charging module arranged in the body. The bottom of the body is provided with an accommodating cavity, the desk lamp switch is arranged on the inner wall surface of the top of the accommodating cavity, and the outer wall surface of the top of the body is provided with a groove corresponding to the desk lamp switch. A user can completely avoid the desk lamp switch when the wireless charging module of the desk lamp is used for charging, the desk lamp switch is prevented from being triggered by mistake, the interaction effect between the wireless charging function and the lighting function of the desk lamp is eliminated, and the user can use the desk lamp switch conveniently.

### CROSS-REFERENCE TO RELATED APPLICATIONS

The present application is a continuation of International Application No. PCT/CN2019/074782 filed on Feb. 11, 2019, which claims priority to Chinese Patent Application No. 201920140660.8 filed on Jan. 25, 2019. All applications are incorporated herein by reference in their entireties.

### TECHNICAL FIELD

The invention relates to the technical field of daily necessities, in particular to a wooden base of a desk lamp.

### BACKGROUND

A wireless charging type device transmits electric energy to the battery of the electronic equipment in a wireless transmission mode through the coil, the charging mode is operated by only placing the electronic equipment on a charging platform, and the wireless charging mode which has convenient operation avoids the trouble of wiring.

In the field of LED lighting, the desk lamps always appear in the life of people by being combined with the wireless charging. However, the desk lamp is compact in structure, the volume and the occupied area of a base of the desk lamp are small, and a desk lamp switch arranged on the periphery of a charging platform of a wireless charging coil will affect the base easily when a user uses the wireless charging, so that it affects the lighting function of the normal use of the desk lamp by the user.

### SUMMARY

The technical problem to be solved by the present invention is to provide a wooden base of a desk lamp with a groove for preventing unintended activation.

In order to solve the technical problem, the invention adopts the technical solution that a wooden base of a desk lamp comprises a body, a desk lamp switch and a wireless charging module arranged in the body, wherein the bottom of the body is provided with an accommodating cavity, the desk lamp switch is arranged on the inner wall surface of the top of the accommodating cavity, and the outer wall surface of the top of the body is provided with a groove corresponding to the desk lamp switch.

Furthermore, the wireless charging module is positioned at the center of the accommodating cavity, and the desk lamp switch is positioned at the periphery of the wireless charging module.

Furthermore, the depth of the groove ranges from 2 mm to 4 mm, and the width of the opening thereof ranges from 10 mm to 22 mm.

Furthermore, a counter bore communicated with the accommodating cavity is further arranged on the inner wall surface of the top of the body, and the wireless charging module is positioned in the counter bore.

Furthermore, a step portion is arranged at the opening of the counter bore.

Furthermore, a sink slot for accommodating the desk lamp switch is arranged on the inner wall surface of the top of the body.

Furthermore, the wooden base further comprises a guide surface arranged on the outer wall surface of the top of the body, and the groove is positioned in the guide surface.

Furthermore, the guide surface extends to an edge of the body.

Furthermore, the inner surface of the groove is a continuous concave arc-shaped surface.

Furthermore, the distance between the bottom of the groove and the top of the accommodating cavity ranges from 2 mm to 3 mm.

The invention has the beneficial effects that the desk lamp switch is arranged on the inner wall surface of the top of the accommodating cavity, and the outer wall surface of the top of the body is provided with a groove corresponding to the desk lamp switch; and the sunken groove is lower than the outer side wall of the top of the base, a user can completely avoid the desk lamp switch when the wireless charging module of the desk lamp is used for charging, the desk lamp switch is prevented from being triggered by mistake, the interaction effect between the wireless charging function and the lighting function of the desk lamp is eliminated, and the user can use the desk lamp switch conveniently.

### BRIEF DESCRIPTION OF THE DRAWINGS

FIG. 1 is a schematic view showing the overall structure of a wooden base of a desk lamp according to Embodiment 1 of the present invention.

FIG. 2 is a schematic view showing a bottom structure of the wooden base of the desk lamp according to Embodiment 1 of the present invention.

FIG. 3 is a sectional view of the wooden base of the desk lamp according to Embodiment 1 of the present invention.

FIG. 4 is a schematic view showing the overall structure of a wooden base of another desk lamp according to Embodiment 1 of the present invention.

FIG. 5 is a sectional view of the wooden base of another desk lamp according to Embodiment 1 of the present invention.

### DETAILED DESCRIPTION OF THE EMBODIMENTS

In order to explain the technical contents, achieved objects and effects of the present invention in detail, a description is made in combination with the embodiments and the accompanying drawings.

The conception of the invention is as follows: the desk lamp switch is arranged on the inner wall surface of the top of the accommodating cavity, the outer wall surface of the top of the body is provided with a groove corresponding to the desk lamp switch, and a user can completely avoid the desk lamp switch when the wireless charging module of the desk lamp is used for charging.

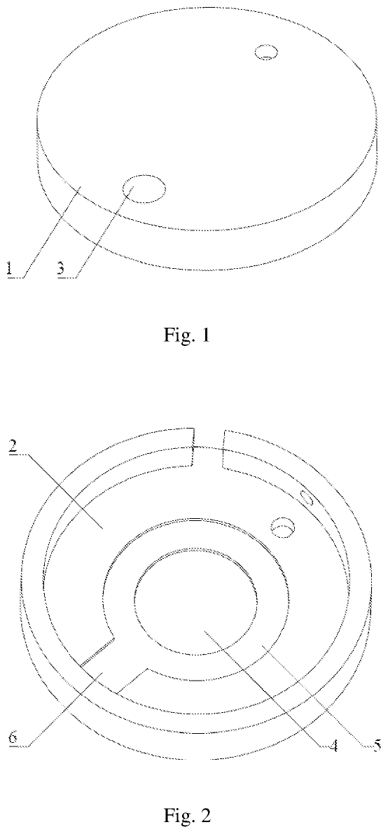

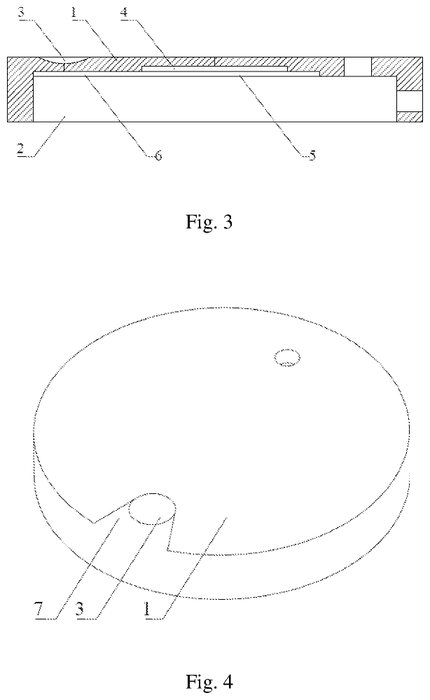

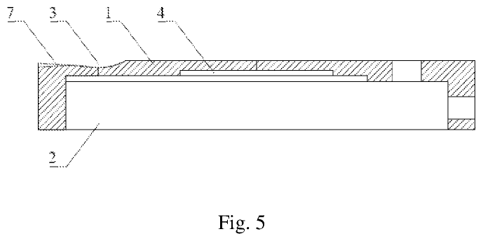

Referring to FIGS. 1-5, a wooden base of a desk lamp comprises a body 1, a desk lamp switch and a wireless charging module arranged in the body, wherein the bottom of the body 1 is provided with an accommodating cavity 2, the desk lamp switch is arranged on the inner wall surface of the top of the accommodating cavity 2, and the outer wall surface of the top of the body 1 is provided with a groove 3 corresponding to the desk lamp switch.

The structural principle of the invention is briefly described as follows. The desk lamp switch is arranged on the inner wall surface of the top of the accommodating cavity, and the outer wall surface of the top of the body is provided with a groove corresponding to the desk lamp switch; and the sunken groove is lower than the outer side wall of the top of the base, and when a user charges the desk lamp by using a wireless charging platform, the desk lamp switch arranged below the groove cannot be touched during the normal charging operation to generate related actions. By means of the arrangement, erroneous switching of the desk lamp switch caused by frequent operation of wireless charging can be avoided.

As can be seen from the above description, the invention has the beneficial effects that the desk lamp switch is arranged on the inner wall surface of the top of the accommodating cavity, and the outer wall surface of the top of the body is provided with a groove corresponding to the desk lamp switch; and the sunken groove is lower than the outer side wall of the top of the base, and a user can completely avoid the desk lamp switch when the wireless charging module of the desk lamp is used for charging, the desk lamp switch is prevented from being triggered by mistake, the interaction effect between the wireless charging function and the lighting function of the desk lamp is eliminated, and the user can use the desk lamp switch conveniently.

Furthermore, the wireless charging module is positioned at the center of the accommodating cavity 2, and the desk lamp switch is positioned at the periphery of the wireless charging module.

It can be seen from the above description that the desk lamp switch and the wireless charging module are staggered, and under the condition that the charging module is running or not, the user can correspondingly operate the desk lamp switch when the desk lamp needs to be turned on or off.

Furthermore, the depth of the groove 3 ranges from 2 mm to 4 mm, and the width of the opening thereof ranges from 10 mm to 22 mm.

It can be seen from the above description that the groove with the depth value range of 2-4 mm is lower than the wireless charging operation platform, the sunken groove avoids all actions of the wireless charging on the wireless charging operation platform, prevents the desk lamp switch arranged below the groove from being triggered by mistake, and the adaptive opening width is convenient for the user to operate.

Furthermore, a counter bore 4 communicated with the accommodating cavity 2 is further arranged on the inner wall surface of the top of the body 1, and the wireless charging module is positioned in the counter bore 4.

As can be seen from the above description, the wireless charging module accommodated in the counter bore has higher electric energy transmission efficiency and may improve the wireless charging rate of the desk lamp.

Furthermore, a step portion 5 is arranged at the opening of the counter bore 4.

Furthermore, a sink slot 6 for accommodating the desk lamp switch is further arranged on the inner wall surface of the top of the body 1.

As can be seen from the above description, the sink slot can reduce the distance between the groove and the desk lamp switch, so that the desk lamp switch can be triggered more sensitively.

Furthermore, the lamp switch further comprises a guide surface 7 arranged on the outer wall surface of the top of the body, and the groove 3 is positioned in the guide surface 7.

Furthermore, the guide surface 7 extends to an edge of the body 1.

According to the description, the transition between the groove and the body is smoother when the guide surface is used, and the operation of switching the desk lamp by the user is simplified.

Furthermore, the inner surface of the groove 3 is a continuous concave arc-shaped surface.

Furthermore, the distance between the bottom of the groove 3 and the top 2 of the accommodating cavity ranges from 2 mm to 3 mm.

According to the above description, the distance between the groove and the accommodating cavity is 2-3 mm, the sensitivity of the desk lamp switch to be triggered is improved by shortening the distance between the user and the desk lamp switch, and the reliability of the desk lamp switch to be triggered is improved.

### Embodiment 1

Referring to FIGS. 1 to 5, the Embodiment 1 of the present invention is as follows. A wooden base of a desk lamp comprises a body 1, a desk lamp switch and a wireless charging module arranged in the body 1, wherein the bottom of the body 1 is provided with an accommodating cavity 2, the desk lamp switch is arranged on the inner wall surface of the top of the accommodating cavity 2, and the outer wall surface of the top of the body 1 is provided with a groove 3 corresponding to the desk lamp switch. In the embodiment, the desk lamp switch is a touch switch, and the touch switch is triggered by touching the bottom of the touch groove 3, so that the lighting of the desk lamp is turned on or off.

The wireless charging module is positioned at the center of the accommodating cavity 2, the desk lamp switch is positioned at the periphery of the wireless charging module, the desk lamp switch and the wireless charging module are staggered, and under the condition that the charging module is running or not, the user can correspondingly operate the desk lamp switch when the desk lamp needs to be turned on or off.

Optionally, the depth of the groove 3 is 2-4 mm, and the width of the opening thereof is 10-22 mm. Preferably, the depth of the groove 3 is 2.5 mm. The sensitivity of the desk lamp switch to be triggered is improved by shortening the distance between the user and the desk lamp switch, and the reliability of the desk lamp switch to be triggered is improved. 2.5 mm depth of the groove 3 with the opening width of 20 mm is enough to form a height difference with the wireless charging platform, so that it can prevent misoperation of the desk lamp switch arranged below the groove 3 caused by related actions during the wireless charging, and the opening width of 20 mm enables touch control to be simpler and more convenient. Optionally, the inner surface of the groove 3 is a continuous concave arc-shaped surface, and the distance between the bottom of the groove 3 and the top of the accommodating cavity 2 is 2-3 mm. In the embodiment, the wall surface and the bottom surface of the groove 3 have smooth transition. Preferably, the concave arc-shaped surface is a spherical surface, and the spherical radius of the spherical surface where the groove 3 is located is 21.25 mm; the distance between the bottom of the groove 3 and the top of the accommodating cavity 2 is 3 mm, which ensures the structural stability of the body 1; meanwhile, the distance between the user and the desk lamp switch can be shortened, and the user can conveniently control the desk lamp switch.

A counter bore 4 communicated with the accommodating cavity 2 is further arranged on the inner wall surface of the top of the body 1. The depth of the counter bore 4 ranges from 4 to 6 mm. Preferably, the depth of the counter bore 4 is 4 mm, the diameter of the counter bore 4 is 56 mm, and the wireless charging module is positioned in the counter bore 4.

Alternatively, a step portion 5 is arranged at the opening of the counter bore 4. In this embodiment, the step portion 5 is provided around the counter bore 4, the step portion 5 is a circular ring, the circular ring-shaped step portion 5 has a depth of 4 mm and a diameter of 85 mm, and the step portion 5 may provide an accommodating space for the PCB board.

In detail, a sink slot 6 for accommodating the desk lamp switch is further arranged on the inner wall surface of the top of the body 1. Preferably, the sink slot 6 is communicated with the step portion 5, the communicated step portion 5 and the sink slot 6 can be continuously machined by a same milling cutter during machining, and the machining operation procedures are reduced. Optionally, the sink slot 6 has a depth of 2 mm and a length of 22 mm.

In the embodiment, it further comprises a first wire through hole and a second wire through hole, wherein the first wire through hole is arranged on the outer wall surface of the top of the body 1, and the second wire through hole is arranged on the side wall surface of the body 1. Optionally, the thickness of the side wall surface of the body 1 is 10 mm, and the first wire through hole and the second wire through hole are used for wire passing. The first wire through hole is arranged on the outer wall surface of the top of the body 1 far away from the groove 3.

In another implementation solution of the embodiment, it further includes a guide surface 7 arranged on the outer wall surface of the top of the body 1, and the groove 3 is positioned in the guide surface 7. In detail, the guide surface 7 extends to an edge of the body 1. In particular, the guide surface 7 is a sector-shaped guide plane which is arranged between the groove 3 and the edge of the outer wall surface at the top of the body 1 and is mainly used for facilitating fingers of a user to directly extend into the groove 3 and touching the bottom of the groove 3 to control the desk lamp switch.

The structural principle of the invention is briefly described as follows. The touch-control desk lamp switch is arranged on the inner wall surface of the top of the accommodating cavity 2, and the outer wall surface of the top of the body 1 is provided with a groove 3 corresponding to the desk lamp switch, and the distance between the both is 3 mm. The groove 3 which is 2.5 mm sinking from the wireless charging platform is lower than the wireless charging platform on the outer side wall of the top of the base. When a user charges the desk lamp by using the wireless charging platform, the touch switch arranged below the groove 3 cannot be touched during the normal wireless charging operation to generate related actions. By means of the arrangement, erroneous switching of the desk lamp switch caused by frequent operation of wireless charging can be avoided.

In summary, the invention provides a wooden base of a desk lamp. The desk lamp switch is arranged on the inner wall surface of the top of the accommodating cavity, and the outer wall surface of the top of the body is provided with a groove corresponding to the desk lamp switch; and the sunken groove is lower than the outer side wall of the top of the base, a user can completely avoid the desk lamp switch when the wireless charging module of the desk lamp is used for charging, the desk lamp switch is prevented from being triggered by mistake, the interaction effect between the wireless charging function and the lighting function of the desk lamp is eliminated, and the user can use the desk lamp switch conveniently. The desk lamp switch and the wireless charging module are staggered, and under the condition that the charging module is running or not, the user can correspondingly operate the desk lamp switch when the desk lamp needs to be turned on or off. The distance between the groove and the accommodating cavity is 2-3 mm, the sensitivity of the desk lamp switch to be triggered is improved by shortening the distance between the user and the desk lamp switch, and the reliability of the desk lamp switch to be triggered is improved.

The above description is only the embodiments of the present invention and do not limit the patent scope of the present invention. Any equivalent transformations made using the content of the description and drawings of the present invention, or the embodiments directly or indirectly applied in related technical fields, are also included in the scope of patent protection of the present invention.

What is claimed is:

1. A wooden base of a desk lamp, comprising a body, a desk lamp switch and a wireless charging module arranged in the body,
wherein a bottom of the body is provided with an accommodating cavity, the desk lamp switch is arranged on an inner wall surface of a top of the accommodating cavity, and an outer wall surface of a top of the body is provided with a groove corresponding to the desk lamp switch.

2. The wooden base of the desk lamp according to claim 1, wherein the wireless charging module is positioned at a center of the accommodating cavity, and the desk lamp switch is positioned at a periphery of the wireless charging module.

3. The wooden base of the desk lamp according to claim 1, wherein a depth of the groove ranges from 2 mm to 4 mm, and a width of an opening of the groove ranges from 10 mm to 22 mm.

4. The wooden base of the desk lamp according to claim 1, wherein a counter bore communicated with the accommodating cavity is further arranged on an inner wall surface of the top of the body, and the wireless charging module is positioned in the counter bore.

5. The wooden base of the desk lamp according to claim 4, wherein a step portion is arranged at an opening of the counter bore.

6. The wooden base of the desk lamp according to claim 5, wherein a sink slot for accommodating the desk lamp switch is further arranged on the inner wall surface of the top of the body.

7. The wooden base of the desk lamp according to claim 1, further comprising a guide surface arranged on the outer wall surface of the top of the body, wherein the groove is positioned in the guide surface.

8. The wooden base of the desk lamp according to claim 7, wherein the guide surface extends to an edge of the body.

9. The wooden base of the desk lamp according to claim 1, wherein an inner surface of the groove is a continuous concave arc-shaped surface.

10. The wooden base of the desk lamp according to claim 1, wherein a distance between a bottom of the groove and the top of the accommodating cavity ranges from 2 mm to 3 mm.
